(19) United States
(12) Patent Application Publication
(10) Pub. No.: US 2023/0384510 A1
(43) Pub. Date: Nov. 30, 2023

(54) HOLLOW-CORE FIBRE FOR TRANSMITTING LASER LIGHT

(71) Applicant: Rheinmetall Waffe Munition GmbH, Südheide (DE)

(72) Inventors: Markus JUNG, Eicklingen (DE); Klaus LUDEWIGT, Hamburg (DE); Björn WEDEL, Berlin (DE)

(21) Appl. No.: 18/230,809

(22) Filed: Aug. 7, 2023

Related U.S. Application Data
(63) Continuation of application No. PCT/EP2022/052904, filed on Feb. 7, 2022.

(30) Foreign Application Priority Data
Feb. 10, 2021 (DE) 10 2021 103 135.4

(51) Int. Cl. G02B 6/02; G02B 6/032

(52) U.S. Cl. CPC G02B 6/02328; G02B 6/032

(57) ABSTRACT

The invention relates to a microstructured hollow-core fiber comprising a microstructured hollow core extending along the hollow-core fiber. Said hollow core: has microstructures having at least one first refractive index n; is surrounded by an inner fiber cladding having a refractive index n_inner; and has an outer protective cladding which has a protective cladding refractive index n_outer and which sheathes the inner fiber cladding. The hollow-core fiber is characterized in that: the hollow-core fiber has at least one further cladding which is arranged between the inner fiber cladding and the outer protective cladding so as to sheathe the inner fiber cladding and which has a further refractive index n_w; and the further refractive index n_w is greater than the further refractive index.

### CROSS-REFERENCE TO RELATED APPLICATIONS

This application is a continuation application of PCT Application No. PCT/EP2022/052904, filed on 7 Feb. 2022, which claims priority to and benefit of German Patent Application No. 10 2021 103 135.4, filed on 10 Feb. 2021. The entire disclosures of the applications identified in this paragraph are incorporated herein by references.

### FIELD

The present invention relates to a microstructured hollow-core fiber configured for transmitting laser light according to the preamble of claim 1. Such a microstructured hollow-core fiber comprises a microstructured hollow core extending along the hollow-core fiber. The hollow core has microstructures having at least one first refractive index n and is surrounded by an inner fiber cladding having a refractive index n_inner. Whenever fiber claddings are mentioned in this application, fiber claddings made of transparent material, which are conductive for the laser light, are meant in each case, in which the laser light can be guided by means of total internal reflections.

### BACKGROUND

In the case of hollow-core fibers, the glass used as the core of the fiber in the case of well-known optical fibers (solid-core fibers) is replaced with a gas or a vacuum, which gives the fiber a “holey center.” Hollow-core fibers as such are known, for example, from the publication “https://www.photonics.com/Articles/Hollow-Core_Fibers_Outperform_Silica_glass/a6448?refer=picks #comments.”

It is also known to transmit single-mode laser radiation of a high pulse peak power by means of microstructured hollow-core fibers. However, solid-core fiber structures are typically used for the transmission of single-mode laser radiation of high average power.

When transmitting laser power by means of hollow-core fibers, higher losses usually occur than in the case of transmission by means of solid-core fibers. These losses are in the range of approximately 0.5% per meter of fiber length. The laser power which is not transmitted and lost as lost power is emitted by the cladding, i.e., the sheath of the beam-conducting hollow core, into the environment transversely to the longitudinal extension of the hollow-core fiber, which is undesirable.

The sheath has at least one fiber cladding that concentrically surrounds the hollow core and a protective cladding (jacket, or buffer) concentrically surrounding the fiber cladding. At high average laser powers (in the kilowatt range), the jacket material and/or the fiber claddings and thus the hollow-core fiber as a whole can be damaged by the lost power emitted transversely to the longitudinal extension of the hollow-core fiber.

If single-mode laser radiation of high average power is guided in a solid-core fiber, the intrinsic losses are lower than in the case of transmission in a hollow-core fiber. However, the high field strengths of the laser light generate undesirable non-linear effects in the fiber material of the solid-core fiber. The length of the transmission path is thus limited as a function of the laser power, for example. A loss of the transmission properties of the fiber material and even destruction of the fiber material of the solid-core fiber can be observed.

### SUMMARY

Against this background, the object of the present invention is to provide a hollow-core fiber of the type mentioned at the outset, by means of which higher average laser light powers than before can also be transmitted, such as those which occur, for example, with continuous-wave laser light. The continuous-wave powers involved here are within the kilowatt range. The pulse peak powers reach into the gigawatt range.

This object is achieved by the sum of the features of claim 1. The solution according to the invention differs from the prior art mentioned at the outset, in particular, in that the hollow-core fiber has at least one further fiber cladding which is arranged so as to sheathe the innermost fiber cladding and has a further refractive index n_w, and in that the refractive index n_inner of the innermost fiber cladding is greater than the further refractive index n_w.

The invention therefore provides at least one further fiber cladding which surrounds the inner fiber cladding, said further fiber cladding having a lower refractive index than the inner fiber cladding.

The radially inner first fiber cladding is therefore optically denser than the radially outer second fiber cladding. This facilitates a total internal reflection of light which propagates in the radially inner first fiber cladding and which is incident on the interface between the radially inner first and the radially outer second fiber cladding, which favors low-loss wave guidance in the radially inner first fiber cladding and thus reduces an undesired transfer of lost light propagating in the radially inner first fiber cladding into the radially outer second fiber cladding.

In this way, low-loss wave guidance for the lost light that is not transmitted in the hollow core by the microstructure of the hollow-core fiber is made possible within the radially inner first fiber cladding. As a result, uncontrolled and undesired transverse emission is reduced. As a result of the reduction of this lost power which is emitted transversely to the longitudinal extension of the fiber, damage to the fiber claddings is prevented.

The invention thus allows for transmission of laser radiation of high average power through microstructured hollow-core fibers by means of targeted guidance inside the fiber claddings of the lost light occurring during beam guidance through hollow-core fibers.

This lost radiation is in particular prevented by the invention from exiting the microstructured fiber line laterally in an uncontrolled manner and, in doing so, damaging either the jacket or buffer or the environment. The lost light can then be dissipated in a controlled manner and possibly absorbed by means of the wave guidance achieved with the invention when exiting the microstructured hollow-core fiber line.

The present invention thus provides a hollow-core fiber which prevents the lost power from exiting, which otherwise could cause destruction of the hollow-core fiber or the surrounding protective cladding. The invention thus allows for transmission of laser light of high average power (CW laser light) through a hollow-core fiber.

The invention allows for targeted dissipation and guidance of the lost light and thus for transmission of higher average laser powers than in the prior art, which consists of microstructured hollow-core fibers having only one fiber cladding and one protective cladding. Only the invention makes it possible to use microstructured hollow-core fibers for transmitting high CW laser powers.

A preferred embodiment of the invention is characterized in that the hollow-core fiber has at least two further fiber claddings, each of which has a refractive index, at least one of the refractive indices of the at least two further fiber claddings being less than the refractive index of the innermost fiber cladding.

It is also preferred that the refractive index of one of two further fiber claddings that sheathes the other of the two further fiber claddings is less than the refractive index of the sheathed further fiber cladding.

Preferred embodiments are characterized in that at least two further fiber claddings are present, such that an innermost (first) fiber cladding is concentrically sheathed by a second fiber cladding (which can also be a protective cladding), said second fiber cladding being concentrically sheathed by a third fiber cladding (which can also be a protective cladding), and in that the fiber claddings each have a refractive index unique thereto, the refractive index of a radially outer fiber cladding always being greater than the refractive index of a fiber cladding that extends radially inwards further in.

Another preferred embodiment of the invention is characterized in that material thicknesses of the fiber claddings and of the outer protective cladding are dimensioned such that lost light coupled into the inner fiber cladding or the further fiber cladding from the microstructured hollow core undergoes total internal reflections there. Material thicknesses preferred for this purpose are between four times and six times, in particular five times, the laser light wavelength.

It is also preferred that the microstructured hollow-core fiber has an input end which is configured for coupling laser light into the microstructured hollow core and has an output end which is configured for coupling out laser light from the microstructured hollow core.

It is further preferred that the hollow-core fiber is configured to guide laser light (lost light) coupled into the inner fiber cladding or the further fiber cladding from the microstructured hollow core by means of wave guidance to the output end of the microstructured hollow-core fiber, and to allow the laser light to exit from the fiber claddings there.

Another preferred embodiment is characterized in that the hollow-core fiber has at least one mode stripper which is arranged between the input end and the output end and which is configured to couple out laser light (lost light), coupled into the fiber claddings and/or the protective cladding from the microstructured hollow core, from said fiber claddings transversely to the longitudinal extension of said fiber claddings.

It is also preferred that the hollow-core fiber has multiple mode strippers distributed over the length of the microstructured hollow-core fiber.

This embodiment allows for controlled dissipation of lost power. The lost power can thus be laterally coupled out of the hollow-core fiber in a controlled manner without causing damage. Transportation of undesirably high lost power along the longitudinal extension can thereby be prevented, since the laterally outcoupled portion no longer has to be guided up to the exit end of the hollow-core fiber.

Another embodiment is the additional or alternative use of a so-called “airclad” between the first and second fiber cladding or further optional claddings.

By means of these air claddings, the advantage of a higher numerical aperture in comparison to embodiments without such air claddings is achieved.

Further advantages are described in the dependent claims, the description and the accompanying figures.

It should be understood that the features mentioned above and those still to be explained below can be used not only in the respectively specified combinations but also in other combinations, or alone, without departing from the scope of the present invention.

### BRIEF DESCRIPTION OF DRAWINGS

Embodiments of the invention are shown in the drawings and explained in more detail in the following description. Identical reference signs in the different figures each denote the same elements. The figures show the following in schematic form:

FIG. 1 shows a cross-section through a known hollow-core fiber;

FIG. 2 shows a longitudinal section of the hollow-core fiber from FIG. 1;

FIG. 3 shows a cross-section of a hollow-core fiber according to the invention; and

FIG. 4 shows a longitudinal section of the hollow-core fiber from FIG. 3.

### DETAILED DESCRIPTION

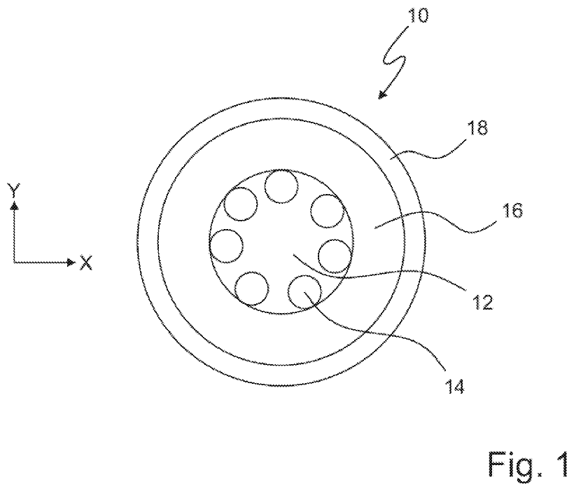

More specifically, FIG. 1 shows a cross-section of a microstructured hollow-core fiber 10 that is assumed to be known.

The sectional plane is perpendicular to the longitudinal extension of the hollow-core fiber. The sectional plane is, for example, an x-y plane of a Cartesian coordinate system. In this case, the longitudinal extension is oriented locally, i.e., in the sectional plane, parallel to the z-direction of the coordinate system.

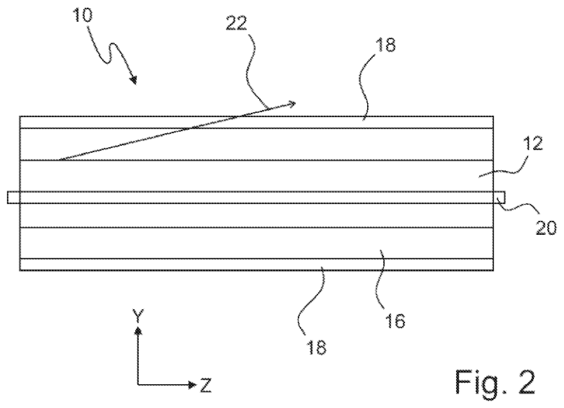

FIG. 2 shows a microstructured hollow-core fiber 10, of the like shown in FIG. 1, in a longitudinal section. The longitudinal section is defined in that it follows the longitudinal extension of the hollow-core fiber 10 such that the center of a hollow core 12 of the hollow-core fiber 10 is always located in the plane of the drawing.

The microstructured hollow-core fiber 10 has a microstructured hollow core 12 extending along the hollow-core fiber 10. The hollow core 12 has microstructures 14 having at least one first refractive index n and is surrounded by an inner fiber cladding 16 having a refractive index n_inner, such that the inner fiber cladding radially delimits the hollow core. The inner fiber cladding is sheathed by an outer protective cladding 18 which has a protective cladding refractive index n_outer.

FIGS. 1 and 2 therefore illustrate the overall structure of a hollow-core fiber 10 that is assumed to be known.

In the known hollow-core fiber 10, the first refractive index n is typically equal to the refractive index n_inner of the inner fiber cladding 16, while the refractive index n_outer of the protective cladding 18 is typically greater than the refractive index n_inner.

During propagation of single-mode laser light 20 having a high mean power value, losses occur, which are also referred to below as lost light 22. In the prior art, this lost light 22 exits laterally from the hollow-core fiber 10 uncontrolled via the inner fiber cladding 16 and the outer protective cladding 18 and can, in particular, damage the outer protective cladding 18 and possibly also objects in the environment of the hollow-core fiber 10 and/or injure persons in said environment.

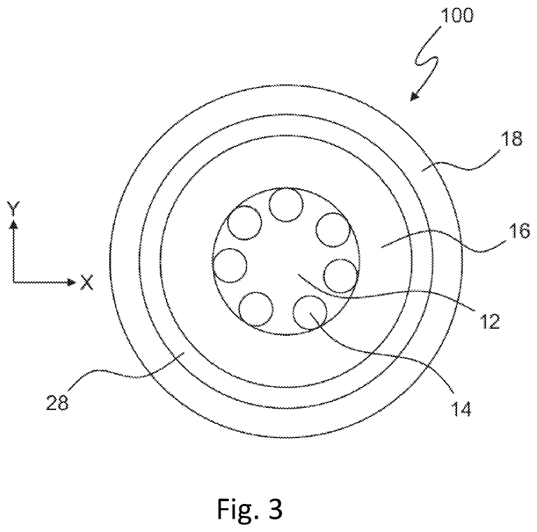

FIG. 3 shows a cross-section of an exemplary embodiment of a hollow-core fiber 100 according to the invention for transmitting laser light. Here, too, the sectional plane is, for example, an x-y plane of a Cartesian coordinate system.

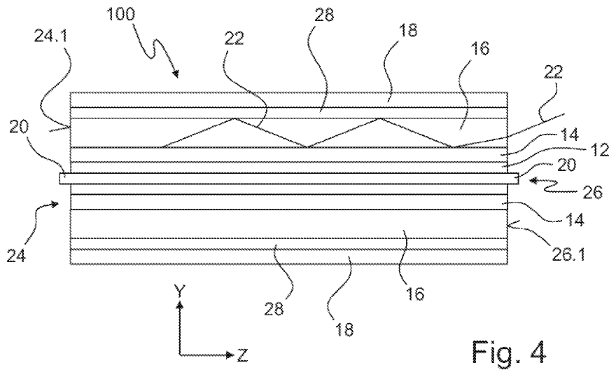

FIG. 4 shows a microstructured hollow-core fiber 100, of the like shown in FIG. 3, in a longitudinal section. The longitudinal section is defined in that it follows the longitudinal extension of the hollow-core fiber 100 such that the center of the hollow core of the hollow-core fiber always lies in the plane of the drawing.

In this case, the longitudinal extension is oriented locally, i.e., in the sectional plane, parallel to the z-direction of the coordinate system.

The microstructured hollow-core fiber 100 has a microstructured hollow core 12 extending along the hollow-core fiber 100. The hollow core 12 has microstructures 14 having at least one first refractive index n and is surrounded by an innermost fiber cladding having a refractive index n_inner, and therefore the innermost fiber cladding 16 radially delimits the hollow core 12. The innermost fiber cladding 16 is sheathed by an outer protective cladding 18 which has a protective cladding refractive index n_outer.

The microstructured hollow-core fiber 100 has an input end 24 which is configured for coupling laser light into the microstructured hollow core 12, and has an output end 26 which is configured for coupling out laser light 20 from the microstructured hollow core 12. For this purpose, the input end 24 and the output end 26 each have an end face 24.1, 26.1 which is oriented transversely to the longitudinal direction of the hollow-core fiber 100. The single-mode laser light 20 propagating in the hollow core 12 then strikes the end face 26.1 used for outcoupling in such a way that it does not undergo total internal reflection there and instead is transmitted. Similarly, the incoupling takes place, for example, via the end face 24.1 used for incoupling. End faces used for incoupling and outcoupling can also be arranged on lateral projections or lateral incisions of the hollow-core fiber 100.

FIGS. 3 and 4 therefore illustrate the overall structure of an exemplary embodiment of a hollow-core fiber 100 according to the invention.

In addition to the innermost fiber cladding 16 and the outer protective cladding 18, the hollow-core fiber 100 has at least one further cladding 28 which is arranged between the innermost fiber cladding 16 and the outer protective cladding 18 so as to sheathe the innermost fiber cladding 16. The sheaths mentioned in this application are preferably concentric sheaths.

In the hollow-core fiber 100 according to the invention, the microstructures 14 have a first refractive index n. The innermost fiber cladding 16 has a refractive index n_inner, and the outer protective cladding 18 has a protective cladding refractive index n_outer.

The at least one further fiber cladding 28 provided in a preferred embodiment, which is arranged between the innermost fiber cladding 16 and the outer protective cladding 18 so as to sheathe the innermost fiber cladding 16, has a further refractive index n_w. The further refractive index n_w is less than the refractive index n_inner, and the further refractive index n_w is greater than the refractive index n_outer of the protective cladding 18.

Therefore, the inner fiber cladding 16, which is radially further in relative to the further fiber cladding 28 and thus closer to the microstructures 14 and the hollow core 12, is optically denser than the further fiber cladding 28. The greater optical density of the innermost fiber cladding 16 favors the occurrence of total internal reflections of lost light 22 which propagates in the innermost fiber cladding 16 and is incident on the interface to the further fiber cladding 28. In addition, the further refractive index n_w is greater than the refractive index n_outer of the protective cladding 18.

The greater optical density of the further fiber cladding 28 compared to the optical density of the outer protective cladding 18 favors the occurrence of total internal reflections of lost light 22 which propagates in the further fiber cladding 28 and is incident on the interface to the outer protective cladding.

The material thicknesses of the fiber claddings 16, 28 and of the outer protective cladding 18 are dimensioned such that lost light 22 coupled into the fiber claddings 16, 28 from the microstructured hollow core 12 undergoes total internal reflections there.

This results in the effect that controlled dissipation of lost light 22 is favored by means of wave guidance taking place along the innermost fiber cladding 16 and the further fiber cladding 28. This desired favoring effect desirably occurs at the expense of loads of uncontrolled radial emission of lost light 22 that has crossed over from the hollow core 12 into the innermost fiber cladding 16. In this way, the hollow-core fiber 100 is configured to guide laser light coupled into the fiber claddings 16, 28 from the microstructured hollow core 12 by means of wave guidance to the output end 26 of the microstructured hollow-core fiber 100 and to allow the lost light 22 to exit there from the fiber claddings 16, 28.

As an alternative or in addition to controlled outcoupling at the output end 26 of the hollow-core fiber 100, the lost light 22 propagating along the hollow-core fiber 100 in the fiber claddings 16, 28 can also be coupled out of the fiber claddings 16, 18 in a controlled manner by means of mode strippers attached laterally to the hollow-core fiber 100. Mode strippers of this kind can be implemented, for example, as local projections or incisions in the fiber claddings 16, 28 conducting lost power 22. Projections or incisions of this kind have interfaces which are oriented in such a way that lost light 22 impinging there does not undergo total internal reflection, but rather is deflected radially in a controlled manner, and thus is coupled laterally out of the hollow-core fiber 100 in a controlled manner.

One or more mode strippers can be arranged between the input end 24 and the output end 26 and, in this way, can couple out lost light 22, coupled out of the microstructured hollow core 12 into the fiber claddings 16, 28 and/or the protective cladding 18, from said claddings transversely to the longitudinal extension of said claddings.

Another possible embodiment is the additional or alternative use of a so-called “airclad” between the innermost fiber cladding 16 and the further fiber cladding 28 or further optional fiber claddings.

The exemplary embodiment of a hollow conductor shown in FIGS. 3 and 4 has two further fiber claddings 28 and 18 in addition to the radially innermost fiber cladding 16. The radially outermost further fiber cladding 18 is preferably a protective cladding and concentrically surrounds the other further fiber cladding 28. The further fiber cladding 28 concentrically surrounds the innermost fiber cladding 16.

At least one of the refractive indices of the at least two further fiber claddings 18, 28 is less than the refractive index of the innermost fiber cladding 16.

The refractive index of one of the two further fiber claddings that sheathes the other of the two further fiber claddings is less than the refractive index of the sheathed further fiber cladding, in this case the further fiber cladding 28. The sheathing further fiber cladding is, in this case, the fiber cladding 18.

In one embodiment with only one further fiber cladding, said further fiber cladding can simultaneously be the protective cladding. Said protective cladding can thus be made of silicone and thus also guide the exiting laser light in the first fiber cladding by means of total internal reflections. Such an exemplary embodiment emerges, for example, from the exemplary embodiment of FIGS. 3 and 4 by omitting the fiber cladding 18 that extends furthest out radially.

If three concentrically arranged fiber claddings 16, 28, 18 of the central fiber cladding extending radially between the innermost and the outermost fiber cladding have a lower refractive index than the innermost fiber cladding, the fiber cladding extending furthest out does not necessarily have to have a low refractive index since the laser light is already guided through the central fiber cladding in the innermost fiber cladding. It would also be sufficient if only one of the two further fiber claddings has a lower refractive index than the radially innermost fiber cladding in order to guide the laser light within the arrangement by means of total internal reflections.

What is claimed is:

1. A hollow core fiber configured to transmit laser light, which comprises a microstructured hollow core extending in the fiber direction, which hollow core has microstructures having at least one first refractive index n and is surrounded by an inner fiber cladding having a refractive index n_inner, characterized in that the hollow-core fiber has at least one further fiber cladding which is arranged so as to sheath the inner fiber cladding and has a further refractive index n_w, and in that the refractive index n_inner of the inner fiber cladding is greater than the further refractive index n_w.

2. The hollow-core fiber according to claim 1, wherein it has at least two further fiber claddings, each of which has a refractive index, at least one of the refractive indices of the at least two further fiber claddings being less than the refractive index of the innermost fiber cladding.

3. The hollow-core fiber according to claim 2, wherein the refractive index of one of two further fiber claddings that sheathes the other of the two further fiber claddings is less than the refractive index of the sheathed further fiber cladding.

4. The hollow-core fiber according to claim 3, wherein it has at least two further fiber claddings, an innermost, first fiber cladding being concentrically sheathed by a second fiber cladding, said second fiber cladding being concentrically sheathed by a third fiber cladding, and in that the fiber claddings each have a refractive index unique thereto, the refractive index of a radially outer fiber cladding always being greater than the refractive index of a fiber cladding that extends radially inwards further in, and therefore the refractive index of the arrangement of fiber claddings decreases from the inside outwards.

5. The hollow-core fiber according to claim 1, wherein the material thicknesses of the inner fiber cladding and of the further fiber cladding are dimensioned such that lost light coupled into the inner fiber cladding and/or the further fiber cladding from the microstructured hollow core undergoes total internal reflections there.

6. The hollow-core fiber according to claim 1, wherein the microstructured hollow-core fiber has an input end which is configured for coupling laser light into the microstructured hollow core and has an output end which is configured for coupling out laser light from the microstructured hollow core.

7. The hollow-core fiber according to claim 1, wherein it is configured to guide lost light coupled into the inner fiber cladding from the microstructured hollow core by means of wave guidance to the output end of the microstructured hollow-core fiber and to allow the lost light to exit there from the inner fiber cladding.

8. The hollow-core fiber according to claim 1, wherein it has at least one mode stripper which is arranged between the input end and the output end and which is configured to couple out lost light, coupled into the inner fiber cladding or the further fiber cladding and/or the protective cladding from the microstructured hollow core, from the microstructured hollow-core fiber transversely to the longitudinal extension thereof.

9. The hollow-core fiber according to claim 8, wherein it has multiple mode strippers distributed over the length of the microstructured hollow-core fiber.

10. The hollow-core fiber according to claim 1, wherein an air cladding layer is arranged between the inner fiber cladding and the further fiber cladding.

11. The hollow-core fiber according to claim 1, wherein an air cladding layer is arranged between the radially outermost fiber cladding and the protective cladding.

12. The hollow-core fiber according to claim 1, wherein a refractive index of the microstructures is equal to the refractive index n_inner of the inner fiber cladding.

13. The hollow-core fiber according to claim 1, wherein the further fiber cladding concentrically surrounds the inner fiber cladding.
